(19) United States
(12) Patent Application Publication
(10) Pub. No.: US 2009/0324940 A1
(43) Pub. Date: Dec. 31, 2009

(54) SELF-ADHESIVE MATERIAL OF HYDROGENATED BLOCK COPOLYMERS AND PROTECTIVE FILM FOR SMOOTH AND ROUGH SURFACES PRODUCED THEREOF

(75) Inventors: Nicolai Böhm, Hamburg (DE); Michael Janning, Munster (DE); Andreas Hagemann, Rhede (DE); Domenico Boccuto, Stadtlohn (DE)

Correspondence Address: Anscomb, Brian C., 875 Third Avenue, 8th Floor, New York, NY, 10022, US

(73) Assignee: TESA AG, HAMBURG (DE)

(21) Appl. No.: 12/375,575

(22) PCT Filed: Aug. 3, 2007
(86) PCT No.: PCT/EP07/58059

§ 371 Date: Sep. 11, 2009

(30) Foreign Application Priority Data
Aug. 10, 2006 (DE) 10 2006 037 627.7

(51) Int. Cl. C09J 153/02; B32B 27/08; B29C 47/06; C08L 53/02

(52) U.S. Cl. 428/337; 428/355 BL; 264/173.19; 428/353; 525/89

(57) ABSTRACT

The invention relates to the self-adhesive material of hydrogenated block copolymers or a mixture thereof, comprising polymer blocks of vinyl aromatics (A-blocks) and such made by polymerization of 1.3 dienes (B-blocks), wherein the self-adhesive material is mixed with 25 to 100 parts per weight of polyisobutylene with an average molecular weight M_{w}>200 000 g/mol, 3 to 40 phr (per hundred rubber=in relation to the blockcopolymeres) adhesive resin and 0.1 to 5 phr light protecting agent in relation to 100 parts per weight of the blockcopolymeres.

The invention relates to a self-adhesive composition comprising hydrogenated block copolymers and also to the use thereof in protective films which adhere securely to smooth and rough surfaces and can be removed from them easily and without residue even after UV exposure.

Heightened requirements in the design of articles of everyday use are continually giving rise to new, sensitive surfaces, and the modern consumer expects a flawless product on purchase.

The sensitive surfaces of many consumer goods are therefore protected with surface-protection films, which protect them effectively from minor mechanical events and help to prevent value-reducing marring and dulling. Surface-protection films are generally composed of a backing film, which develops the actual protective effect, and a self-adhesive composition, which on the one hand fixes the film securely to the article to be protected, from the outset, and on the other hand must ensure easy and traceless releasability.

The conditions to which the protected surface and the protective film are exposed may be very different depending on the article and its intended use. In practice these conditions range from a bonding time of just a few hours under normal ambient conditions, as during assembly, for instance, through to months-long bonding times under adverse conditions, including UV exposure or high atmospheric humidity.

The necessary bond strength of the protective film depends on the substrate material and on the nature of its surface. This surface may be glossy or matt, or smooth or variously textured. No one surface-protection product covers all of the requirements. This explains the multiplicity of surface-protection film products that are on offer.

Dominating the sector are protective films with a carrier made from polyolefins and with self-adhesive compositions made from acrylic ester polymers, applied both from solution and from aqueous dispersion. The tack of the acrylic ester polymers can be given a variety of formulations, and for numerous applications they also function entirely properly. In general, however, the relatively polar acrylic ester polymers tend to exhibit peel increase on the substrate—that is, to increase the strength of their adhesion to the substrate over time as compared with the initial level of adhesion.

Likewise widespread are black/white polyolefin films which are colored white on the outside and black beneath and are usually combined with natural-rubber self-adhesive compositions. This film, which is opaque to light, is intended to protect the light-sensitive natural-rubber self-adhesive composition from light-induced decomposition, which would lead automatically to intolerable residues of adhesive.

This type of protective film is employed especially when acrylic ester polymers are not suitable; in other words, when their polar nature leads to severe interaction with the substrate, which is frequently the case on PVC, for example, such as window profiles.

Generally speaking, natural-rubber self-adhesive compositions are the more suitable self-adhesive compositions for surface protection, since they are nonpolar and have less of a tendency toward peel increase than acrylic ester polymers. Their substantial drawback is the instability to light, which can be compensated only by means of a film which is opaque to light but which, consequently, is less attractive. On optical grounds or else on practical grounds, a transparent protective film is sometimes more desirable, since the area covered can be viewed.

In many cases, therefore, a film that would be advantageous would be a film combining a transparent carrier with a nonpolar natural-rubber self-adhesive composition.

One solution may be the use of synthetic rubbers which, in contradistinction to natural rubber, are in some cases also available in a hydrogenated and therefore more light-stable form. Nevertheless, natural rubber cannot be swapped directly for a synthetic rubber; synthetic-rubber compositions must overall be given a different formulation.

One attempt in this direction is disclosed in WO 03/18702 A1, where preference is given to using styrene block copolymers, which may also be hydrogenated, together with tackifier resins and polymeric plasticizer comprising polyisobutylene, which must have a softening temperature below 25° C. and is therefore liquid at room temperature. Although, as quoted, the protective film does function on a number of painted surfaces, it is nevertheless the case that on numerous substrates, particularly after exposure to temperature, residues of adhesive are observed which indicate inadequate cohesion of the composition.

WO 03/018701 Al discloses a self-adhesive protective film for surface-protection applications which has a single-ply or multi-ply carrier layer, more particularly a polyolefinic carrier layer, and a self-adhesive layer. The construction of the self-adhesive composition is as follows:
30% to 70% by weight of one or more elastomers based on block copolymers, including polymer blocks formed from vinylaromatics (A blocks), preferably styrene, and polymer blocks formed by polymerization of 1,3-dienes (B blocks), preferably butadiene and isoprene and/or their hydrogenation products, and also
30% to 70% by weight of tackifier resins, at least half of the tackifier resins being liquid resins having a softening point of below 25° C. as measured using the ring and ball method.

EP 1 388 582 A1 discloses a self-adhesive protective film whose self-adhesive composition is based on a polyisobutylene and/or a styrene block copolymer. More precise details concerning the type of polyisobutylene or its molecular weight, and also concerning mixing ratios, are absent. This suggests that any conceivable mixing ratios or any polyisobutylenes form a suitable self-adhesive composition for a surface-protection film. It is indeed possible to find mixing ratios which adhere too strongly or too weakly. With polyisobutylenes which are liquid at room temperature, the cohesion can become too low, as already observed above. If the fraction of styrene block copolymer is too great, then irreversible imprints of creases, bubbles or the edges of the film are observed on sensitive substrates such as paints.

It is an object of the present invention to provide a self-adhesive composition comprising hydrogenated block copolymers, and a protective film produced using said composition, that does not have the disadvantages of the prior art, or not to the same extent. In particular, the proposed self-adhesive composition comprising hydrogenated block copolymers ought to have a light stability such that it can be used, in particular, on transparent carrier films, so that a protective film for smooth substrates can be provided that is composed of a transparent carrier film and the self-adhesive composition of the invention, said film not harboring the risk of premature, light-induced decomposition of adhesive, and at the same time playing out the advantages of nonpolar, rubberlike self-adhesive compositions.

This object is achieved by means of a self-adhesive composition of the kind recorded in the main claim. The dependent claims provide advantageous developments of the self-adhesive composition, and also a protective film produced using it.

The invention accordingly provides a self-adhesive composition comprising hydrogenated block copolymers or a mixture of such, comprising polymer blocks formed from vinylaromatics (A blocks), preferably styrene, and polymer blocks formed by polymerization of 1,3-dienes (B blocks), preferably butadiene and isoprene and/or their hydrogenation products. The self-adhesive composition is blended with 25 to 100 parts by weight of polyisobutylene having a weight-average molecular weight M_{w}>200 000 g/mol, 3 to 40 phr (per hundred rubber=based on the block copolymers) of tackifier resin, and 0.1 to 5 phr of light stabilizer, based on 100 parts by weight of the block copolymers.

Elastomers employed include those based on block copolymers including polymer blocks formed by vinyl-aromatics (A blocks), preferably styrene, and polymer blocks formed by polymerization of 1,3-dienes (B blocks), preferably butadiene and isoprene, and preferably their hydrogenated derivatives. Both homopolymer blocks and copolymer blocks can be utilized in accordance with the invention. Resultant block copolymers may contain identical or different B blocks. Block copolymers can have a linear A-B-A structure; likewise possible for use are block copolymers of radial design and also star-shaped and linear multiblock copolymers. Further components present may include A-B diblock copolymers. Block copolymers of vinylaromatics and isobutylene are likewise possible for use in accordance with the invention. All of the aforementioned polymers may be utilized alone or in a mixture with one another.

Instead of the polystyrene blocks it is also possible to utilize polymer blocks based on other aromatics-containing homopolymers and copolymers (preferably C₈ to C₁₂ aromatics) having glass transition temperatures of > about 75° C., such as α-methylstyrene-containing aromatics blocks, for example.

Instead of styrene-butadiene block copolymers and styrene-isoprene block copolymers and their hydrogenation products, including styrene-ethylene/butylene block copolymers and styrene-ethylene/propylene block copolymers, it is likewise possible in accordance with the invention to utilize block copolymers and their hydrogenation products which utilize further polydiene-containing elastomeric blocks, such as, for example, copolymers of two or more different 1,3-dienes. Further suitable for use in accordance with the invention are functionalized block copolymers, such as maleic anhydride-modified or silane-modified styrene block copolymers, for example.

In one outstanding embodiment of the invention the elastomers are hydrogenated predominantly in the middle block, and in particular are hydrogenated completely in the middle block.

The polyisobutylenes are homopolymers of isobutene and by their nature are relatively insensitive to the effects of light, since they contain no unsaturated bonds. The polyisobutylenes are available commercially in numerous molecular weights. Typically, polyisobutenes having weight-average molar masses of from M_{w}=30 000 g/mol up to more than 4 000 000 g/mol are offered. Below a weight-average molar mass of about M_{w}=200 000 g/mol, the polyisobutylenes are liquid at room temperature; above that molar mass, they are rubberlike. In the latter case they can be brought into a readily processible form by granulation.

Only polyisobutylenes having a weight-average molar mass of above M_{w}=200 000 g/mol have proved to be suitable as an addition to hydrogenated block copolymers in the sense of the invention, since only in that case is the cohesion sufficient even under demanding conditions.

The amount of polyisobutylenes with weight-average molecular weight M_{w}>200 000 g/mol that is used is 25 to 100 parts by weight of polyisobutylene per 100 parts by weight of block copolymer.

Since the stated block copolymers, even in a mixture with polyisobutylenes, have by their nature only a low level of pressure-sensitive adhesion, they must be made more pressure-sensitively adhesive for successful bonding to relatively rough substrates and/or to substrates with low surface tension (such as polypropylene, for instance), through the addition of tackifier resins.

Suitable tackifiers for the self-adhesive composition of the invention are tackifier resins, especially hydrogenated tackifier resins.

Those with preferred suitability include the following:
hydrogenated polymers of dicyclopentadiene (for example, Escorez 5300 series; Exxon Chemicals)
hydrogenated polymers of preferably C₈ and C₉ aromatics (for example, Regalite and Regalrez series; Hercules Inc.//Arkon P series; Arakawa); these can be formed by hydrogenating polymers comprising pure aromatics streams or else by hydrogenating polymers based on mixtures of different aromatics
partially hydrogenated polymers of C₈ and C₉ aromatics (for example, Regalite and Regalrez series; Hercules Inc.//Arkon M; Arakawa)
hydrogenated polyterpene resins (for example, Clearon M; Yasuhara)
hydrogenated C₅/C₉ polymers (for example, ECR-373; Exxon Chemicals)
aromatics-modified, selectively hydrogenated dicyclopentadiene derivatives (for example, Escorez 5600 series; Exxon Chemicals) and/or
hydrogenated and partially hydrogenated rosin-based resins (for example Foral, Foralyn; Hercules//Hydrogral; DRT).

For the use of the self-adhesive composition of the invention in a protective film without UV exposure it is also possible to use unhydrogenated tackifier resins alone or as blend components of the hydrogenated tackifier resins. As surface-protection film exposed to UV radiation, hydrogenated hydrocarbon resins are principally employed.

In order further to improve the light stability, the self-adhesive composition must be admixed with light stabilizers or other stabilizers, primarily on account of the sensitivity of the resins, even if they are hydrogenated. These stabilizers ensure, primarily, the interruption of the free-radical degradation processes induced by radiation or heat, especially with exposure to atmospheric oxygen, which may affect not only the elastomers but also the tackifier resin or resins. Light stabilizers of this kind are described in Gaechter and Müller, Taschenbuch der Kunststoff-Additive, Munich 1979, in Kirk-Othmer (3rd) 23, 615 to 627, in Encycl. Polym. Sci. Technol. 14, 125 to 148, and in Ullmann (4th) 8, 21; 15, 529, 676. HALS light stabilizers in particular are suitable for the self-adhesive composition of the invention. The amount of the light stabilizer, relative to the elastomers, is 0.1 to 5 phr.

The light stability can be increased further through the use of antioxidants (for example, Irganox 1010 or trisnonylphenyl phosphite), but is not mandatory.

The hydrogenated block copolymers and the polyisobutylene can be dissolved homogeneously, in all proportions in accordance with the invention, in suitable solvents such as, for example, toluene or toluene/benzine mixtures. These solutions can be coated out in any desired thickness onto carrier materials, and freed from the solvent by exposure to heated, moving air.

The components of the self-adhesive composition of the invention can also be mixed solventlessly, for example, in an internal mixer or, in a melted form, in suitable assemblies such as, for example, extruders or compounders. They may also be formed to a film, solventlessly, in calenders or extruders with a slot die, for example, and applied to the carrier web.

The self-adhesive composition of the invention is also suitable for being shaped simultaneously with the carrier in a multi-ply coextrusion process to give a completed surface-protection film.

These properties by themselves support the use of the adhesive of the invention on a carrier film which ultimately can be used for the protection of surfaces. The general expression “protective film” encompasses, for the purpose of this invention, all sheetlike structures such as two-dimensionally extended films or film sections, tapes with extended length and limited width, tape sections, die cuts, labels, and the like. The desire most often is for flexible protective films which can easily conform to the centers of the substrate by extending. In this case, the protective film produced from the adhesive of the invention has a carrier preferably comprising polyolefins. These may be, for example, polyethylene, polypropylene, and also blends or copolymers thereof (for example, random copolymer or polypropylene block copolymer).

In order to set particular mechanical properties such as toughness, flexibility, adhesion to the adhesive, extrusion behavior or particularly smooth surface structure, the films may also include different amounts of further polyolefin copolymers such as copolymers of ethylene and α-olefins such as 1-butene, 1-hexene, 1-octene (called LLDPE, VLDPE or ULDPE, or metallocene-PE, according to fraction and preparation process), but also ethylene-styrene copolymers, ethylene with polar comonomers such as acrylic acid or vinyl acetate, and copolymers of propylene with α-olefins, such as ethylene, 1-butene, 1-hexene, 1-octene.

Likewise suitable are PVC films, especially plasticized PVC films.

In some cases the desire is for dimensionally stable protective films which should not stretch when being applied or removed. In that case films that are employed are those comprising monoaxially or biaxially oriented polyolefins or comprising polymers with a high elasticity modulus, such as, for example, polystyrene, polycarbonate, polyamide, polyesters (polyethylene terephthalate, polybutylene terephthalate) or polymethyl methacrylate. Also embraced by the concept of the invention are film composites made of different layers of materials.

In one advantageous development of the invention the thickness of the carrier film is between 20 and 80 μm.

The invention is aimed particularly at light-stable protective films. In order to give the carrier film the requisite UV stability, the addition of light stabilizers is preferred. The state of the art in relation to this can be found in the same sources already given in respect of the light stabilizers for the self-adhesive composition. The amount of the light stabilizer ought to be at least 0.15% by weight, preferably at least 0.30% by weight, based on the carrier film.

The use of antioxidants for the film (for example, Irganox 1010 or trisnonylphenyl phosphite), though advantageous, is not mandatory. Further suitable UV absorbers, light stabilizers, and aging inhibitors are listed in EP 0 763 584 A1.

Although transparency is often desired, there are cases where, for reasons of recognition or light shielding, the requirement is for opacity or even imperviousness to light. In these cases the carrier may be filled with opaque fillers such as titanium dioxide or carbon black. This ensures opacity and a further improvement in the light stability of the carrier film.

In order to scavenge metals which catalyze decomposition it is possible that metal deactivators, which are integrated in the carrier film, are advantageous, including hydrazines and hydrazides.

Optical design is served using dyes or color pigments, both alone and in conjunction with fillers, in order to obtain colored transparency, translucency or opaque color.

Lubricants and antiblocking agents such as erucamide, oleamide, and glyceryl monostearate, and also acid scavengers such as calcium stearate and other metal soaps, can be employed, with the proviso that they do not adversely affect the adhesive properties of the self-adhesive composition, through migration or transfer from the reverse of the carrier film to the self-adhesive composition.

To reduce the cost of the film, or in order to achieve particular properties, it is also possible to employ other fillers such as chalk or talc.

The preferred polyolefin films are produced by the relevantly known methods, such as the chill roll method, in which the melt emerging from a slot die is cast onto a chill roll, on which the melt solidifies to form a film. Another widespread method is the blown film method, in which the melt is extruded as a parison from an annular die and inflated to a greater or lesser extent in order to obtain the desired dimensions (thickness and diameter) of the parison.

If necessary, the anchorage of the self-adhesive composition on the carrier film may be enhanced by coating with a primer or with a layer of adhesion promoter, as an aid to anchorage. This purpose may also be served by corona pretreatment or flame pretreatment of the side of the film that is to be coated.

On the reverse of the protective film it is possible, if necessary, for a reverse-face varnish to be applied in order to promote the unwind properties of the protective film wound to an Archimedean spiral. This reverse-face varnish may for that purpose be equipped with silicone compounds or fluorosilicone compounds and also with polyvinyl stearylcarbamate, polyethylenimine stearylcarbamide or organofluorine compounds as abhesive substances.

In the case of multi-ply coextrusion it is advantageous to coextrude the layer comprising the release agent with the overall construction.

The self-adhesive composition of the invention is distinguished by a good initial force of adhesion not only to smooth or glossy substrates but also, in particular, to rough and textured substrates. The adhesiveness increases in the course of storage for a prolonged period, even at elevated temperature, to a slight degree.

The protective film produced therefrom, even in conjunction with a light-transmitting carrier film, exhibits good light stability for months. Even after exposure to heat and sunlight, it can be detached easily and without residue from the substrate. In this context, the substrate does not undergo any change in appearance such as yellowing, alteration in gloss, or instances of swelling.

On account of the unexpected positive properties, the self-adhesive composition can be used in a protective film which can be employed on freshly painted surfaces of vehicles such as automobiles, or automobile parts, as assembly protection or transit protection, or else can be used for protecting smooth and rough paint, metal, plastic or glass surfaces.

The self-adhesive composition of the invention and the surface-protection films produced from it are described below in a preferred version, on the basis of a number of examples, without any intention that the invention should thereby likewise be subject to any restriction whatsoever.

Also given are comparative examples, which show unsuitable self-adhesive compositions and protective films produced from them.

### EXAMPLES

All self-adhesive compositions for the production of specimens were prepared by weighing in the components of the composition and dissolving them in the toluene solvent at a solids concentration of 20%. The self-adhesive compositions were coated out using a laboratory coating machine on a corona-pretreated, colorlessly transparent LDPE film 50 μm thick, light-stabilized with 0.2% of Chimassorb 944 (poly[[6-[(1,1,3,3-tetramethylbutyl)amino]-s-triazine-2,4-diyl]-[(2,2,6,6-tetramethyl-4-piperidyl)imino]hexamethylene-[(2,2,6,6-tetramethyl-4-piperidyl)imino]], a HALS light stabilizer from CIBA) in a coat thickness such that drying in a drying cabinet at 95° C. for 4 minutes gave an adhesive coat weight of 10 g/m².

After cooling, the specimens were lined with a siliconized release film and after a waiting time of not less than 48 hours were slit to form strips 20 mm wide. The tests described below were carried out using these strips.

Assessment Criteria

The criteria for an application-compatible self-adhesive composition for surface-protection films are
sufficient instantaneous adhesion
a moderate increase in bond strength after temperature exposure
a moderate increase in bond strength and residue-free removability after UV exposure
no surface alterations after demasking.

This is elucidated in more detail below:

Instantaneous Adhesion

Sufficient instantaneous adhesion on the substrate to be protected must be provided, so that the surface-protection film is easy to apply and adheres securely from the outset. One measure of this is the instantaneous bond strength, in other words the force needed to peel the surface-protection film from the substrate again directly after application.

Peel Increase

So that the substrate to be protected can be easily demasked again, the self-adhesive surface-protection film must not exhibit excessive peel increase; in other words, the difference between the peel strength after a long period of bonding and the instantaneous bond strength must not be too great. This is all the more important given that surface-protection films are frequently employed in large dimensions and hence the force expended for demasking can be considerable.

Surface Alteration

A surface-protection film shall protect the substrate from damage or soiling, but must not alter the substrate itself.

Discoloration and irreversible deformation of the surface, in the form of an imprint of creases or film structures incorporated in the bonding process, are unwanted, as are adhesive residues and deposits.

UV Stability

The effect of UV light on the self-adhesive surface-protection film must include neither embrittlement or tearing of the carrier on demasking, nor detriment to the cohesion of the self-adhesive composition such that there are residues on the substrate.

Implementation of the Tests, and Evaluation Schemes

The specimens, slit to strips, were applied to various representative substrates, and the bond strength was determined by means of a tensile testing machine, both instantaneously and after different stresses.

Particular attention was paid here to the assessment of the substrate after demasking.

Instantaneous Adhesion

The instantaneous adhesion was measured by a method based on the ASTM D3330 bond strength measurement method, on smooth test plaques produced from polycarbonate (PC), unplasticized polyvinyl chloride (PVC), acrylonitrile-butadiene-styrene copolymer (ABS), window glass (glass), and one-component polyurethane varnish (1K PU varnish). The peel angle was 180° and the peel speed 300 mm/min. The bond strength was measured within five minutes after bonding.

An instantaneous adhesion of 0.2 N/cm or more was evaluated as good.

Peel Increase

A long bonding time was simulated by thermal exposure of the specimens bonded to the substrates, at an elevated temperature of 80° C. for six days. After the heat-exposed specimens had cooled to room temperature, the peel force was measured by a method based on the ASTM D3330 bond strength measurement method.

The peel increase (Δ) is calculated as the difference in peel force after thermal exposure and instantaneous adhesion.

An increase in the peel force by not more than 1 N/cm was evaluated as good.

Independently of the peel increase, a peel force after thermal exposure of more than 2 N/cm was evaluated as negative.

Instantaneous Adhesion

After the thermally exposed specimens had been removed by peeling, the area of former bonding was inspected. The assessment was positive (satisfactory, OK) if there were no visible changes apparent to the substrate.

UV Stability

The UV stability was tested by exposure to UV light in the Q-panel QUV/SE weathering instrument. The radiation output was 0.92 W/m²/nm, which is achieved using lamp type UVA-340. For this test, the irrigation unit was not in operation.

At regular intervals of approximately 24 hours, the specimens were demasked and the substrate was inspected for residues, as a sign of incipient weakness in cohesion.

The specimens were evaluated as being sufficiently UV-stable if no residues of adhesive were apparent after at least 400 h of UV exposure.

Molecular Weight Determination

The molecular weight determinations of the weight-average molecular weights M_{w} took place by means of gel permeation chromatography (GPC). The eluent used was THF (tetrahydrofuran) with 0.1% by volume trifluoroacetic acid. Measurement took place at 25° C. The preliminary column used was PSS-SDV, 5μ, 10³ Å, ID 8.0 mm×50 mm. Separation was carried out using the columns PSS-SDV 5μ, 10³ and also 10⁵ and 10⁶, each of ID 8.0 mm×300 mm. The sample concentration was 4 g/l, the flow rate 1.0 ml per minute. Measurement was carried out against PMMA standards.

### Formulas of the examples and counterexamples

In accordance with the invention, the self-adhesive compositions selected to illustrate the invention are composed of hydrogenated block copolymers and polyisobutylenes. The numbers in the examples and counterexamples indicate the parts by weight of the components in the formulation. M_{w} designates the weight-average molecular weight. HC resin identifies a hydrocarbon resin.

### EXAMPLES

| Substance | Type | E-1 | E-2 | E-3 |
|---|---|---|---|---|
| SEPS | Septon 2063 | 100 | | |
| | (Kuraray) | | | |
| SEBS | G-1657 | | 100 | 100 |
| | (Kraton) | | | |
| PIB (M_{w} = 340 000 g/mol) | Oppanol B50 | 100 | 100 | 100 |
| | (BASF) | | | |
| PIB (M_{w} = 36 000 g/mol) | Oppanol B10 | | | |
| | (BASF) | | | |
| Rosin, fully hydrogenated | Regalite R1090 | 35 | 35 | |
| | (Eastman) | | | |
| HC resin, fully hydrogenated | Foral 85E | | | 35 |
| | (Eastman) | | | |
| HALS-type light stabilizer | Tinuvin 622 | 1 | 1 | 1 |
| | (Ciba) | | | |

Septon 2063 is an SEPS with a styrene content of 13% by weight and with an average molecular weight M_{w} of 65 000.

The Kraton G-1657 is an SEBS likewise with a styrene content of 13% by weight, and with a diblock content of 30% and an average molecular weight M_{w} of 100 000.

### COUNTEREXAMPLES

| Substance | Type | C-1 | C-2 | C-3 | C-4 |
|---|---|---|---|---|---|
| SEPS | Septon 2063 | | | | |
| | (Kuraray) | | | | |
| SEBS | G-1657 | 100 | 100 | 100 | 100 |
| | (Kraton) | | | | |
| PIB (M_{w} = 340 000 g/mol) | Oppanol B50 | | 200 | | 100 |
| | (BASF) | | | | |
| PIB (M_{w} = 36 000 g/mol) | Oppanol B10 | | | 100 | |
| | (BASF) | | | | |
| Rosin, fully | Regalite | | 53 | 35 | |
| hydrogenated | R1090 | | | | |
| | (Eastman) | | | | |
| HC resin, fully | Foral 85E | 18 | | | 35 |
| hydrogenated | (Eastman) | | | | |
| HALS-type light | Tinuvin 622 | 0.5 | 1.5 | 1 | |
| stabilizer | (Ciba) | | | | |

### Test Results

### EXAMPLES

| | | | |
|---|---|---|---|
| Substrate | E-1 | E-2 | E-3 |

Instantaneous adhesion (in N/cm)

| | | | |
|---|---|---|---|
| PC | 1.2 | 1.3 | 1.3 |
| PVC | 1.3 | 1.5 | 1.1 |
| ABS | 0.8 | 0.9 | 0.8 |
| glass | 1.2 | 1.4 | 1.4 |
| 1K PU varnish | 0.8 | 0.9 | 0.9 |
| Eloxal | 0.3 | 0.3 | 0.4 |
| PE | 0.2 | 0.2 | 0.3 |

Bond strength after thermal exposure (in N/cm)

| | | | |
|---|---|---|---|
| PC | 1.7 | 1.9 | 1.8 |
| PVC | 1.8 | 1.8 | 1.3 |
| ABS | 1.7 | 1.8 | 1.7 |
| glass | 0.8 | 0.9 | 0.5 |
| 1K PU varnish | 1.4 | 1.5 | 1.5 |
| Eloxal | 1.2 | 1.2 | 1.2 |
| PE | 0.3 | 0.3 | 0.4 |

Peel increase Δ (in N/cm)

| | | | |
|---|---|---|---|
| PC | 0.5 | 0.6 | 0.5 |
| PVC | 0.5 | 0.3 | 0.2 |
| ABS | 0.9 | 0.9 | 0.9 |
| glass | −0.4 | −0.5 | −0.9 |
| 1K PU varnish | 0.6 | 0.6 | 0.6 |
| Eloxal | 0.9 | 0.9 | 0.8 |
| PE | 0.1 | 0.1 | 0.1 |

Surface assessment after thermal exposure

| | | | |
|---|---|---|---|
| PC | OK | OK | OK |
| PVC | OK | OK | OK |
| ABS | OK | OK | OK |
| glass | OK | OK | OK |
| 1K PU varnish | OK | OK | OK |
| Eloxal | OK | OK | OK |
| PE | OK | OK | OK |

UV stability (time until appearance of residues, in hours)

| | | | |
|---|---|---|---|
| Glass | 663 | 781 | 541 |

### COUNTEREXAMPLES

| | | | | |
|---|---|---|---|---|
| Substrate | C-1 | C-2 | C-3 | C-4 |

Instantaneus adhesion (in N/cm)

| | | | | |
|---|---|---|---|---|
| PC | 0.7 | 1.6 | 1.8 | 1.3 |
| PVC | 0.6 | 1.5 | 1.7 | 1.1 |
| ABS | 0.5 | 1.6 | 1.5 | 0.8 |
| glass | 0.4 | 1.6 | 1.5 | 1.4 |
| 1K PU varnish | 0.4 | 1.2 | 1.1 | 1.0 |
| Eloxal | 0.0 | 0.3 | 0.3 | 0.4 |
| PE | 0.0 | 0.2 | 0.3 | 0.2 |

Bond strength after thermal exposure (in N/cm)

| | | | | |
|---|---|---|---|---|
| PC | 2.1 | 2.7 | 2.7 | 1.9 |
| PVC | 1.5 | 2.1 | 2.3 | 1.3 |
| ABS | 1.7 | 2.9 | 3.0 | 1.9 |
| glass | 0.6 | 1.9 | 2.5 | 0.4 |
| 1K PU varnish | 1.5 | 2.0 | 2.4 | 1.5 |
| Eloxal | 0.7 | 1.7 | 1.9 | 1.2 |
| PE | 0.5 | 1.1 | 1.2 | 0.4 |

Peel increase Δ (in N/cm)

| | | | | |
|---|---|---|---|---|
| PC | 1.4 | 1.1 | 0.9 | 0.6 |
| PVC | 0.9 | 0.6 | 0.6 | 0.2 |
| ABS | 1.2 | 1.3 | 1.5 | 1.1 |
| glass | 0.2 | 0.3 | 1.0 | −1.0 |
| 1K PU varnish | 1.1 | 0.8 | 1.3 | 0.5 |
| Eloxal | 0.7 | 1.4 | 1.6 | 0.8 |
| PE | 0.5 | 0.9 | 0.9 | 0.2 |

Surface assessment after thermal exposure

| | | | | |
|---|---|---|---|---|
| PC | OK | MR | MR | OK |
| PVC | OK | MR | MR | OK |
| ABS | OK | MR | MR | OK |
| glass | OK | OK | OK | OK |
| 1K PU varnish | D | OK | B | OK |
| Eloxal | OK | OK | MR | OK |
| PE | OK | OK | MR | OK |

UV stability (time until appearance of residues, in hours)

| | | | | |
|---|---|---|---|---|
| glass | 663 | 493 | 137 | 112 |

Abbreviations:

| | |
|---|---|
| OK = | no visible alteration to the surface |
| B = | deposit on the substrate |
| MR = | residues of adhesive |
| D = | substrate deformation |

Example E-1, E-2 and E-3 exhibit an application-compatible profile of properties, exhibiting a sufficient instantaneous bond strength of in some case well above 0.2 N/cm, and a moderate peel increase after temperature storage. A value of 2 N/cm is not exceeded. The surfaces of the substrates have not altered as a result of the temperature storage; demasking was possible without residue. At well over 400 hours, the UV stability is well above the suitability threshold. In example E-2, the use of a fully hydrogenated hydrocarbon resin and of the elastomer based on styrene-ethylene/butylene block copolymer has a positive effect on the UV stability.

Counterexample C-1, without use of polyisobutylene and with only styrene-ethylene/butylene block copolymer and resin, exhibits inadequate bond strength on surfaces with low surface tension such as PE and on surfaces with a matt texture such as eloxed aluminum (Eloxal). Despite low instantaneous bond strengths, the bond strengths after thermal storage are decidedly high: that is, this specimen exhibits pronounced peel increase. Furthermore, the sensitive varnish substrate was deformed irreversibly by this specimen.

In counterexample C-2, the polyisobutylene fraction was doubled and hence displaced to outside the upper limit recognized as being preferred. The increased fraction of polyisobutylene weakens the cohesion. Residues of adhesive are left on quite a number of the substrates. The bond strengths after thermal storage are well above 2 N/cm and hence are above the defined limit for the easy demaskability that is required.

Counter example C-3, with low molecular weight polyisobutylene (Oppanol B10), exhibits severe peel increase on polar substrates, and also considerable residues of adhesive after demasking. The cohesion of this type of PIB with relatively low molecular weight is inadequate. This is also clearly apparent in the low UV stability. Furthermore, deposits occur on the varnish substrate.

In counterexample C-4, the UV stabilizer was omitted. Instantaneous adhesion and peel increase are satisfactory. Without stabilization, the stability under UV exposure is below the limit and does not meet the light stability requirements.

1. A self-adhesive composition comprising hydrogenated block copolymers or a mixture of such, comprising polymer blocks formed from vinylaromatics (A blocks) and polymer blocks formed by polymerization of 1,3-dienes (B blocks), the self-adhesive composition being blended with 25 to 100 parts by weight of polyisobutylene having a weight-average molecular weight M_{w}>200 000 g/mol, 3 to 40 parts per hundred rubber, based on the block copolymers of tackifier resin, and 0.1 to 5 parts per hundred rubber of light stabilizer, based on 100 parts by weight of the block copolymers.

2. The self-adhesive composition of claim 1, wherein the vinylaromatics are styrene or are based on C₈ to C₁₂ aromatics.

3. The self-adhesive composition of claim 1, wherein the B blocks are formed by polymerization of butadiene and isoprene and/or their hydrogenation products.

4. The self-adhesive composition of claim 1, wherein the block copolymers are hydrogenated predominantly in the middle block.

5. The self-adhesive composition of at least one of the preceding claims, wherein the tackifier resins are selected from the group consisting of hydrogenated polymers of dicyclopentadiene, hydrogenated polymers of C₈ and C₉ aromatics Partially hydrogenated polymers of C₈ and C₉ aromatics, hydrogenated polyterpene resins, hydrogenated C₅/C₉ polymers, aromatics-modified, selectively hydrogenated dicyclopentadiene derivatives and hydrogenated and partially hydrogenated rosin-based resins.

6. A protective film comprising a self-adhesive composition comprising hydrogenated block copolymers or a mixture of such, comprising polymer blocks formed from vinylaromatics (A blocks) and polymer blocks formed by polymerization of 1,3-dienes (B blocks), the self-adhesive composition being blended with 25 to 100 parts by weight of polyisobutylene having a weight-average molecular weight M_{w}>200 000 g/mol, 3 to 40 parts per hundred rubber, based on the block copolymers of tackifier resin, and 0.1 to 5 parts per hundred rubber of light stabilizer, based on 100 parts by weight of the block copolymers, the self-adhesive composition being applied to at least one side of a carrier film.

7. The protective film of claim 6, wherein the carrier film is a polyolefin film.

8. The protective film of claim 6, wherein the thickness of the carrier film is between 20 and 80 μm.

9. The protective film of claims 6, wherein the carrier film comprises at least one light stabilizer in an amount of at least 0.15% by weight.

10. The protective film of claim 6, wherein the UV transmittance of the protective film in the wavelength range from 290 to 360 nm is below 1%.

11. (canceled)

12. (canceled)

13. A process for producing a self-adhesive protective film of at least one of the preceding claims by simultaneous coextrusion of self-adhesive composition, carrier layer, and, if appropriate, further, auxiliary layers.

14. The self-adhesive composition of claim 2 wherein the vinylaromatics are based on α-methylstyrene-containing aromatic blocks.

15. The self-adhesive composition of claim 1 wherein the B blocks are formed by polymerization of isobutylene.

16. The self-adhesive composition of claim 4 wherein the block copolymers are completely hydrogenated in the middle block.

17. The protective film of claim 6 comprising an adhesion promoter layer disposed between the carrier layer and the self-adhesive composition.
